(19) United States
(12) Patent Application Publication
(10) Pub. No.: US 2025/0306887 A1
(43) Pub. Date: Oct. 2, 2025

(54) TECHNIQUES FOR MANAGING PROPULSION SYSTEM AND FIRMWARE OVER THE AIR FEATURES FOR ELECTRIFIED VEHICLES

(71) Applicant: FCA US LLC, Auburn Hills, MI (US)

(72) Inventor: Abhilash Gudapati, Troy, MI (US)

(21) Appl. No.: 18/619,264

(22) Filed: Mar. 28, 2024

(51) Int. Cl. G06F 8/65

(52) U.S. Cl. CPC G06F 8/65

(57) ABSTRACT

Firmware over-the-air (FOTA) flash update control techniques include receiving, by a FOTA supervisor module connected to a controller area network (CAN) of an electrified vehicle, a FOTA flash update via a wireless communication medium and determine a set of controllers on the CAN that are intended to be flashed by the FOTA flash update, transmitting, by the FOTA supervisor module via the CAN, a FOTA applicability signal indicative of the set of controllers on the CAN that will be flashed by the FOTA flash update and a maximum FOTA time for performing the FOTA flash update, and controlling, by a propulsion supervisory controller connected to the CAN, a propulsion system of the electrified vehicle, based on the FOTA applicability signal, to overcome a conflict between the propulsion system and the performing of the FOTA flash update.

### FIELD

The present application generally relates to vehicle firmware over-the-air (FOTA) flash updates and, more particularly, to techniques for managing propulsion system and FOTA features for electrified vehicles.

### BACKGROUND

Today's vehicles often include a plurality of different electronic control units (ECUs) and the capability to perform firmware over-the-air (FOTA) flash updates. FOTA flash updates are performable by the vehicle in response to an FOTA broadcast and thus differ from conventional manual/supervised flash updates by a vehicle service technician via a physical diagnostic tool. Depending on network conditions and other factors, FOTA flash updates could potentially take a long time (e.g., 30+ minutes). Thus, it is desirable to offer the customer the option of when to perform the FOTA flash update (e.g., now or at a future scheduled time). Current FOTA flash update systems are not configured for propulsion system related activities (e.g., vehicle charging) and FOTA flash updates to co-exist or function simultaneously. Thus, the customer is forced to choose or the vehicle automatically prioritizes one feature over the other. Accordingly, while such conventional FOTA flash update systems do work for their intended purpose, there exists an opportunity for improvement in the relevant art.

### SUMMARY

According to one example aspect of the invention, a firmware over-the-air (FOTA) flash update control system for an electrified vehicle is presented. In one exemplary implementation, the FOTA flash update control system comprises a FOTA supervisor module connected to a controller area network (CAN) of the electrified vehicle, the FOTA supervisor module configured to receive a FOTA flash update via a wireless communication medium and determine a set of controllers on the CAN that are intended to be flashed by the FOTA flash update, and transmit, via the CAN, a FOTA applicability signal indicative of the set of controllers on the CAN that will be flashed by the FOTA flash update and a maximum FOTA time for performing the FOTA flash update, and a propulsion supervisory controller connected to the CAN and configured to control a propulsion system of the electrified vehicle, based on the FOTA applicability signal, to overcome a conflict between the propulsion system and the performing of the FOTA flash update.

In some implementations, the FOTA supervisor module is further configured to receive a customer input to either (i) perform the FOTA flash update immediately or (ii) to perform the FOTA flash update at a future scheduled time. In some implementations, the conflict includes an on-going or future scheduled charging session for a high voltage battery system of the electrified vehicle. In some implementations, the conflict includes an after-run procedure of an engine or a fuel cell system of the electrified vehicle. In some implementations, the propulsion supervisory controller is configured to not perform the FOTA flash update in response to determining that the electrified vehicle is experiencing a refueling operation. In some implementations, the FOTA flash update is performed after a completion of the conflict. In some implementations, the FOTA flash update is performed in priority ahead of the conflict in response to another customer input. In some implementations, when the set of controllers identified by the FOTA applicability signal do not include any controllers of the propulsion system, the propulsion supervisory controller is configured to continue operating the propulsion system of the electrified vehicle while the FOTA flash update is performed.

According to another example aspect of the invention, a FOTA flash update control method for an electrified vehicle is presented. In one exemplary implementation, the FOTA flash update control method comprises receiving, by a FOTA supervisor module connected to a CAN of the electrified vehicle, a FOTA flash update via a wireless communication medium and determine a set of controllers on the CAN that are intended to be flashed by the FOTA flash update, transmitting, by the FOTA supervisor module via the CAN, a FOTA applicability signal indicative of the set of controllers on the CAN that will be flashed by the FOTA flash update and a maximum FOTA time for performing the FOTA flash update, and controlling, by a propulsion supervisory controller connected to the CAN, a propulsion system of the electrified vehicle, based on the FOTA applicability signal, to overcome a conflict between the propulsion system and the performing of the FOTA flash update.

In some implementations, the method further comprises receiving, by the FOTA supervisor module, a customer input to either (i) perform the FOTA flash update immediately or (ii) to perform the FOTA flash update at a future scheduled time. In some implementations, the conflict includes an on-going or future scheduled charging session for a high voltage battery system of the electrified vehicle. In some implementations, the conflict includes an after-run procedure of an engine or a fuel cell system of the electrified vehicle. In some implementations, the method further comprises not performing, by the propulsion supervisory controller, the FOTA flash update in response to determining that the electrified vehicle is experiencing a refueling operation. In some implementations, the FOTA flash update is performed after a completion of the conflict. In some implementations, the FOTA flash update is performed in priority ahead of the conflict in response to another customer input. In some implementations, when the set of controllers identified by the FOTA applicability signal do not include any controllers of the propulsion system, the propulsion supervisory controller is configured to continue operating the propulsion system of the electrified vehicle while the FOTA flash update is performed.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are functional block diagrams of an example vehicle firmware over-the-air (FOTA) flash update control system according to the principles of the present application; and

FIG. 2 is a flow diagram of an example FOTA flash update control method for an electrified vehicle having a propulsion system according to the principles of the present application.

### DESCRIPTION

As previously discussed, current firmware over-the-air (FOTA) flash update systems are not configured for propulsion system related activities (e.g., vehicle charging) and FOTA flash updates to co-exist or function simultaneously. Thus, the vehicle automatically prioritizes one feature over the other, which could frustrate the customer or leave him/her dissatisfied at the missed opportunity to perform some other important vehicle functionalities during the FOTA flash update. This could potentially lead to customer frustration or dissatisfaction as it is a missed opportunity for performing certain activities (e.g., charging). For example, there may be multiple conflicts within the propulsion system functions on electrified vehicles, which have multiple functions in Ignition-off as a part of systemic behavior for electrified vehicles with an engine. These could include, for example only, (1) after-run, which is required to cool turbocharger(s) based on its current state to avoid reliability issues, (2) evaporative emissions (EVAP) system leak checks or customer request Ignition-off high voltage functionalities, such as scheduled high voltage battery charging, cabin conditioning, 12V periodic charging, or vehicle-to-anything (V2X) discharging, or (3) fuel cell after-run or conditioning.

Accordingly, improved FOTA flash update control systems and methods that allow for electrified vehicle propulsion system and FOTA functionality to co-exist are presented herein. Conventional solutions from other original equipment manufacturers (OEMs) either have long timers (e.g., 90+ minutes) for FOTA flash updates to complete or they physically lock/prevent access to the vehicle (doors, charging port, etc.) until the FOTA flash update is complete. In contrast, the newly-proposed techniques introduce a new controller area network (CAN) signal that specifies FOTA applicability (small ECUs, big ECUs, propulsion system ECUs, etc.) for which ECUs will be flashed in a next FOTA flash session. The FOTA supervisor (e.g., a secure gateway module, or SGM) also communicates a maximum FOTA flash time to the propulsion (e-powertrain, or ePT) supervisory controller so that the low voltage (12V) battery can be brought up to a healthy state (to ensure there is 12V power for FOTA flash completion). After-run and refueling statuses and conflicts can also be considered such that the electrified vehicle is safe to power-down and is not stranded at a gas station during the FOTA flash process.

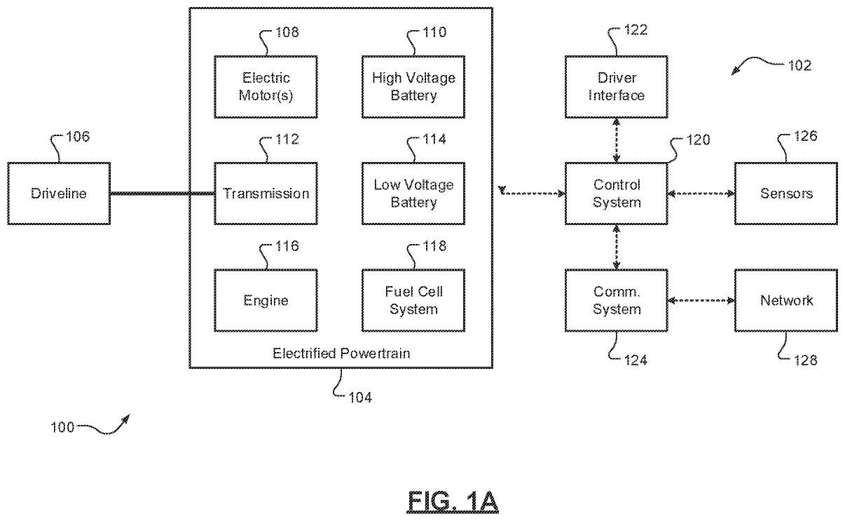

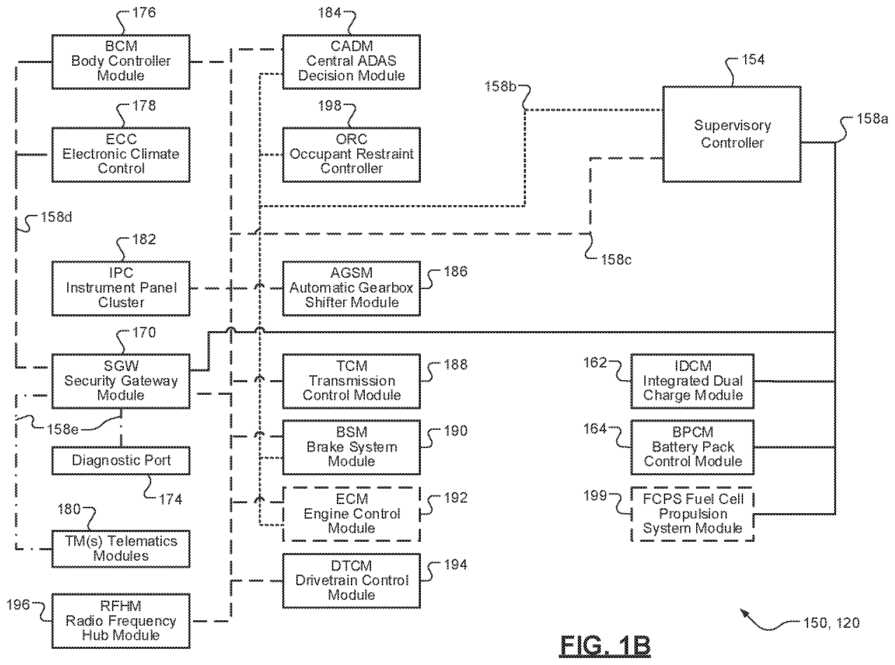

Referring now to FIGS. 1A-1B, functional block diagrams of an electrified vehicle 100 (also referred to as “vehicle 100”) and an example FOTA flash update control system 102, 150 according to the principles of the present application is illustrated. The electrified vehicle 100 generally comprises a propulsion system or electrified powertrain 104 configured to generate and transfer drive torque to a driveline 106 for vehicle propulsion. The electrified powertrain 104 includes at least one electric motor 108 that is powered by a high voltage battery pack or system 110 and is configured to generate torque that is transferred to the driveline 106 via a transmission 112 (e.g., a multi-speed automatic transmission). The electrified powertrain 104 also includes a low voltage (12V) battery system 114 configured to power low voltage loads (not shown). In some implementations, the electrified powertrain 104 further includes an internal combustion engine 116 or a fuel cell system 118 arranged in any suitable configuration and configured to generate additional electrical energy such as for recharging the high voltage battery system 110.

A controller or control system 120 controls operation of the vehicle 100, including primarily controlling the electrified powertrain 104 to generate and transfer a desired amount of drive torque to the driveline 106 to satisfy a driver torque request via a driver interface 122, such as an accelerator pedal. The control system 120 controls the electrified powertrain 104 and other systems as described in greater detail herein based on measurements from a plurality of sensors 126. The plurality of sensors 126 are configured to measure any suitable parameters of the vehicle 100 for use in controlling the same, such as, but not limited to, speeds, torques, temperatures, pressures, and the like. The electrified vehicle 100 also includes a communication system 124 (e.g., one or more transceivers) configured to receive FOTA flash update requests/data from a FOTA master (e.g., a backend server, not shown) via a network 128, such as a long-range wireless communication network (e.g., a cellular data network). The control system 120 is also configured to perform at least a portion of the FOTA flash update control techniques of the present application, which will now be discussed in greater detail below.

FIG. 1B illustrates a specific configuration 150 of the control system 120. As shown, the control system 120 includes a propulsion or ePT supervisory controller (SC) 154 (e.g., a power inverter module, or PIM) for controlling vehicle propulsion (i.e., the electrified powertrain 104) such as, for example, first and second electric motors 108 (e.g., Motors A and B) of the electrified powertrain 108. In one exemplary implementation, the supervisory controller 154 could include a hybrid control processor (not shown) a separate auxiliary HCP (AHCP, not shown) that are configured to perform at least some redundant functions for improved functional safety. The supervisory controller 154 is wakeable via a CAN 158 (CAN bus 158a). Other modules on bus 158a (also referred to as an electrified powertrain or “ePT” bus 158a) include an integrated dual charge module (IDCM) 162, a battery pack control module (BPCM) 164, an optional fuel cell propulsion system (FCPS) module or controller 199, and a security gateway (SGW) module 170. The SGW module 170 is connected to a traditional diagnostic interface port 174 and a FOTA supervisor controller or module is the SGW module 170 in this configuration. Thus, for the remainder of this description, the SGW module 170 can also be referred to as the “FOTA supervisor 170” or the “FOTA supervisor module 170.”

The remaining components of the control system 120 are illustrated and generally include: a body controller module (BCM) 176 and an electronic climate control (ECC) 178 on a CAN bus 158d with the SGW module 170, one or more telematics modules (TMs) 180 on a CAN bus 158e with the SGW module 170, an instrument panel cluster (IPC) 182, a central advanced driver-assistance system (ADAS) decision module (CADM) 184, an automatic gearbox shifter module (AGSM) 186, a transmission control module (TCM) 188, a brake system module (BSM) 190, an optional engine control module (ECM) 192, a drivetrain control module (DTCM) 194, a radio frequency hub module (RFHM) 196 on a CAN bus 158c with the SGW module 170, the BCM 176, and the supervisory controller 154, and an occupant restraint controller (ORC) 198 on a CAN bus 158b with the CADM module 184, the BSM 190, the ECM 192, and the supervisory controller 154. It will be appreciated that there can also be other modules/components that are not illustrated, such as other local interconnect networks (LINs) and the like. It will be appreciated that the illustrated configuration 150 is merely one example configuration or architecture for the control system 120 and the techniques of the present application are applicable to any suitably-configured control systems.

In conventional FOTA flash updates, a FOTA master device (e.g., a backend server) wirelessly broadcasts or transmits a FOTA flash update to the vehicle 100. Larger or more powerful/prominent ECUs in the control system 124 could be capable of performing the FOTA flash update themselves upon receipt via the CAN. Other smaller or less powerful/prominent ECUs in the control system 120, on the other hand, could have their FOTA flash updates coordinated via the SGW or FOTA supervisor module 170. As discussed above, problems or conflicts would arise in conventional FOTA flash update control systems/methods when the FOTA flash update was for any propulsion system controller or ECU (e.g., any ECU on the ePT bus 158a). In order to reduce or eliminate these conflicts, the FOTA supervisor module 170 is configured to publish a new FOTA status CAN signal (“FOTA Applicability”), which could be Small Primary ECU, Small Non-Primary ECU, Big ECU, or Propulsion ECU based on a campaign availability and what controllers/ECUs will be flashed in the next FOTA campaign. The reason for this classification is because, during a FOTA flash, ECUs are requested to be in a silent mode (i.e., only listen, do not communicate). Small Primary ECUs are on a primary CAN bus 158c, which is connected to the IPC 182, as the customer will not be able to see function/feature status while the flash process is on-going, whereas Small Non-Primary ECUs are on different CAN buses, which do not impact function/feature status while the flash process is on-going.

The FOTA supervisor 170 also needs to send a maximum time (“FOTA Max Time to Flash”) for the next FOTA Flash to the ePT supervisory controller, so that the low voltage battery can be proactively brought up to a healthy state when the FOTA Status CAN signal indicates Propulsion ECU(s) (“FOTA Applicability=Propulsion System”). This is to ensure the FOTA flash update can be performed and post FOTA flash the high voltage system can be enabled for Vehicle propulsion. In addition, due to the high priority of refueling for protecting the customer to not get stranded at a refueling station for however long the FOTA is going to take to complete, a FOTA selection interface (i.e., allowing the customer to choose FOTA now or FOTA scheduled later) will not be shown for customer selection after Ignition-off, when a campaign available based on existing FOTA refueling conflict is present. This refueling status of the electrified vehicle 100 could be determined in any suitable manner, such as, for example only, based on the vehicle's location (e.g., proximate to a refueling station), an amount of fuel remaining in a fuel tank of the vehicle 100, an open/closed status of a refueling door of the vehicle, or some combination thereof.

The FOTA flash update process in response to a customer selection of the FOTA Now option will now be described in greater detail. It is noted that all scheduled cabin conditioning and on-demand cabin conditioning features will be disabled as some of them require ignition to be active (ignition-on) and on-demand functions will not be achieved due to lack of customer selection during FOTA flash in progress. Once the customer selects FOTA Now, the propulsion controllers/ECUs will send an additional message based on the FOTA status signal (“FOTA Applicability=Small Primary ECU/Small Non-Primary ECU/Big ECU”) and any existing propulsion system related functions that are on-going such as charging or discharging. For example, a footnote could be displayed on the FOTA Now selection screen that states: “Charging/Discharging functions will continue, information will not be available during Active FOTA Session, use LED information for progress.” Once the customer selects continue through the displayed FOTA high voltage (HV) function select menu (“Continue” or “Discontinue”), the propulsion ECUs will decide if they need to perform shutting down or continue with their functions.

If the selection was to discontinue and if there is no after-run expected to be supported for the engine/fuel cell ECUs, the ePT supervisory controller 154 gets into a low voltage support state based on the current state of charge (SOC), state of health (SOH), and operating characteristics of the low voltage battery 114 before FOTA flash begins based on the FOTA maximum time, then powers down when it has achieved the healthy state for the low voltage system for the FOTA flash to finish and for enabling the propulsion system for the next key cycle. Note that the high voltage battery 110 or HV system always supports the low voltage battery 114 during after-run. If the customer selection was to continue, the ePT supervisory controller 154 continues its current function of charging or discharging ends before FOTA, it can either enter to the Low voltage support state or powers down based on the health of the low voltage battery 114. If within the time of FOTA flash in progress and the high voltage functionality that the customer requested as charging or discharging fails, the customer can use the display/LEDs to understand that the system has failed for some reason, and the next key cycle the customer will get a notification on the reason for failure.

Once the customer selects FOTA Now and the FOTA status signal indicates a propulsion system ECU (“FOTA Applicability=Propulsion System”), an engine ECU (e.g., the ECM 192) checks for conflicts such as after-run or a refueling conflict. If there is a refueling conflict or an after-run conflict, the FOTA flash will be disabled, and a reason will be provided to the customer about the process to be discontinued. The need for after-run takes the highest priority for component protection. Damaging the component might be riskier vs FOTA flash disabled. Note that the customer gets a schedule FOTA only selection if the after-run conflict is set a certain number of times (e.g., 20 times) continuously. In another aspect, the FCPS controller 199 checks for conflicts such as after-run or conditioning required which need high voltage support, if the FCPS controller 199 does not require the support, the ePT SC 154 enters a high voltage disabled state and associated controllers enter ready to flash state awaiting diagnostic commands. The FCPS controller 199 can determine if flash or after-run/conditioning is required based on number of FOTA Now and the FOTA status signal (“FOTA Applicability=Propulsion System”). If the customer request for FOTA Now two times (calibration) and after-run/conditioning takes priority, the after-run/conditioning can be disabled and FOTA Now can continue. This is because there might be other critical reasons where after-run or conditioning might need to be disabled, so it is acceptable for the FCPS controller 199 to disable its after-run based on priority. Once all propulsion system controllers get to a safe state, the FOTA supervisor 170 will communicate through diagnostic messages and finish the FOTA flash.

The FOTA flash update process in response to a customer selection of the FOTA Scheduled option will now be described in greater detail. It is noted that all scheduled cabin conditioning and on-demand cabin conditioning features will be disabled as some of them require ignition to be active and on-demand functions will not be achieved due to lack of customer selection during FOTA flash in progress as the infotainment module holds the selections. Once the customer selects FOTA Schedule and enters the desired scheduled time, the propulsion controllers/ECUs will receive FOTA scheduled time (e.g., in minutes). Once the customer selects FOTA Schedule, the propulsion supervisory controllers will send an additional message based on the FOTA status signal (“FOTA Applicability=Small Primary ECU/Small Non-Primary ECU/Big ECU”) and the existing propulsion functions are also scheduled or are on-going such as charging or discharging. For example, a footnote could be displayed on the FOTA Now selection screen that states: “Charging/Discharging functions will continue, information will not be available during Active FOTA Session, use LED information for progress.”

Once the customer selects continue through the displayed FOTA high voltage (HV) function select menu (“Continue” or “Discontinue”), the propulsion supervisory controllers will decide if they need to perform shutting down or continue with its functions when the FOTA schedule time arrives. If the selection was to Discontinue, the ePT supervisory controller 154 gets into a low voltage support state based on the current SOC, SOH and operating characteristics of the Low Voltage battery before FOTA Flash begins based on the maximum FOTA time (e.g., “FOTA Max time to Flash=xxx minutes”), then powers down when it has achieved the healthy state for the low voltage battery 114 for FOTA to finish and for enabling the propulsion system for the next key cycle. If the selection was to continue, the ePT supervisory controller 154 continues its current function of charging or discharging ends before FOTA, it can either enter to the low voltage support state or powers down based on the health of the low voltage battery 114. If within the time of FOTA flash in progress and the high voltage functionality that the customer requested as charging or discharging fails, the customer can use the display/LEDs to understand that the system has failed for some reason, the next key cycle the customer will get a notification on the reason for failure.

Once the customer selects FOTA Schedule and the FOTA status signal indicates a propulsion system ECU (“FOTA Applicability=Propulsion System”), if the ePT supervisory controller 154 already has a charging or discharging function that is ongoing which is ongoing and conflicts with the scheduled FOTA timing, it will send a pop-up message to the customer mentioning that the scheduled event will continue until FOTA begins and will resume after FOTA is completed. The same function will also be applicable if the ePT supervisory controller 154 detects a conflict on a later scheduled charging or discharging event and informs the customer. The ePT supervisory controller 154 disables all schedule cabin conditioning or selectable cabin conditioning events due to Ignition requirement or selection is disabled during FOTA. If the time for departure for scheduled cabin conditioning meets the requirement target after FOTA is completed, they can enable the feature. In some cases, a reference pop-up message is provided: “The scheduled function conflicts with selected FOTA time—the selected scheduled event ends before FOTA begins and resumes after FOTA is completed. Please change the scheduled FOTA time if necessary.” If there are periodic wakeup functions such as fuel cell conditioning or battery conditioning, the ePT supervisory controller 154 will plan for a new timer after the FOTA flash is completed. In some implementations, the ECM 192 checks for conflicts such as EVAP system leak check. If there is conflict with the EVAP system, the ECM 192 uses the time from the telematics system and reschedules and earlier time for the leak check. The leak check is a procedure which typically takes less than 1 minute (e.g., 30 seconds on an average worst case), but could also be significantly longer (e.g., ˜7 minutes). Once all of the propulsion controllers get to a safe state, the FOTA supervisor 170 will communicate through diagnostic messages and finish the FOTA flash.

In contrast to the above-described techniques of the present application, the conventional techniques employed by other OEMs provide special recommendations that either the vehicle cannot be accessed or must be locked, in some cases to unplug the electrified vehicle supply equipment (EVSE) or even the key fob should not be in the range of the vehicle which might cause interruption to an ongoing FOTA event. This system design provides maximum usage of customer selected options even during conflicts of scheduled events or existing customer functions that can help the customer while a possible FOTA flash can occur. This provides high customer satisfaction and some specific features to co-exist giving the benefits for charging, discharging, high voltage component conditioning, 12V energy support for next key cycle due to extended FOTA sessions, maintaining 12V for long FOTA sessions. Some key improvements of the technique of the present application when compared to any of the existing FOTA designs for vehicles include: (1) charging can continue when there is no FOTA impact to propulsion controllers in a scheduled FOTA event or FOTA Now event; (2) discharging can continue when there is no FOTA impact to propulsion controllers; (3) 12V support can be performed to avoid systemic failures during FOTA or after FOTA is completed; (4) 12V support can be designed based on the maximum time for flash, rather than continuously using high voltage reducing the range of the vehicle; (5) a customer interface to inform and for customer to select if they would like to proceed with using high voltage system for their benefit; (6) reduction in conflicts for other propulsion controllers when FOTA is not applicable for them; and (7) conflict improvement on controllers like FCPS where the system can decide the priority of FOTA Now vs their own function of post ignition-off.

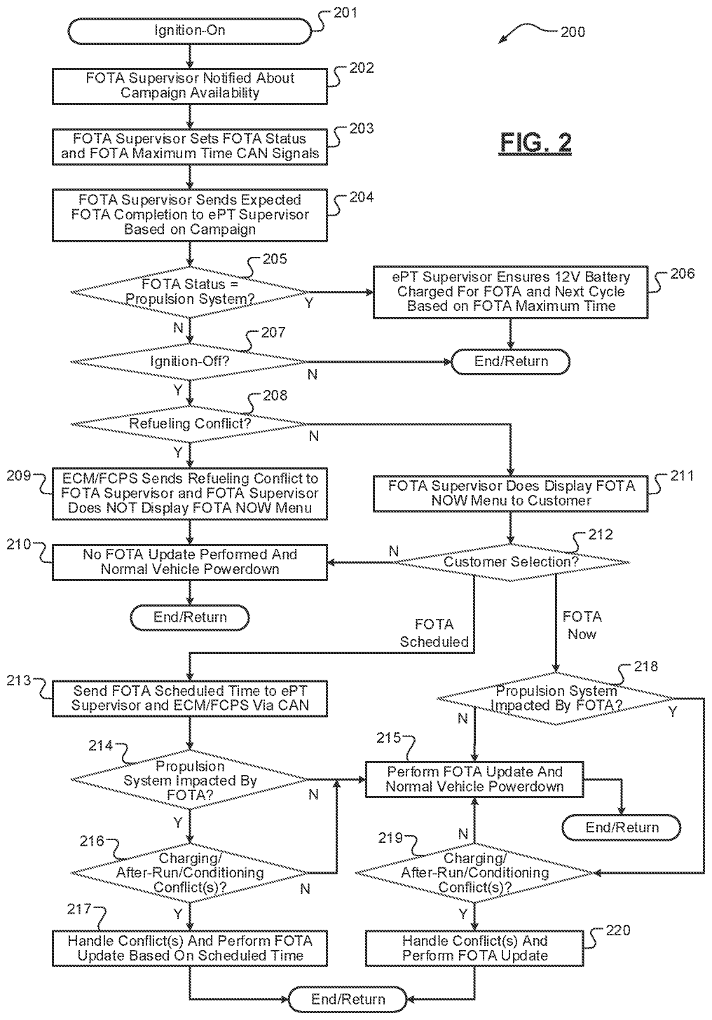

Referring now to FIG. 2, a flow diagram of an example FOTA update control method 200 for an electrified vehicle according to the principles of the present application is illustrated. While the method 200 references the electrified vehicle 100 and its control system 120, 150, it will be appreciated that the method 200 could be applicable to any suitably configured electrified vehicle. The method 200 begins at 201 where a status of the electrified vehicle 100 is ignition-on. At 202, the FOTA supervisor 170 is notified about FOTA campaign availability from the other modules on the CAN (e.g., the ePT supervisory controller 154). At 203, the FOTA supervisory 170 sets the FOTA status or FOTA availability signal and a maximum FOTA time signal. This can include transmitting or broadcasting these signals via the CAN. At 204, the FOTA supervisor 170 sends an expected FOTA flash update completion time to the ePT supervisory controller 154 based on the FOTA campaign. At 205, it is determined whether the FOTA status or availability indicates that an ECU/controller of the propulsion system is targeted by the FOTA flash update. When true, the method 200 proceeds to 206 where the ePT supervisory controller 154 ensures that the low voltage (12V) battery 114 is sufficiently charged/prepared for the FOTA flash update and for a next key cycle based on the maximum FOTA time. The method 200 then ends or returns to 201 during a next ignition-on cycle. When the determination at 205 is false, the method 200 proceeds to 207.

At 207, it is determined whether a transition from ignition-on to an ignition-off state of the electrified vehicle 100 has occurred. When false, the method 200 ends or returns (e.g., to 201). When true, the method 200 proceeds to 208. At 208, it is determined whether a refueling conflict is present. As previously discussed herein, refueling operations will be given deference over immediate FOTA flash updates so as to not strand a customer and their vehicle 100 at a refueling station (e.g., gasoline or hydrogen (H2) refueling). When false, the method 200 proceeds to 209. When true, the method 200 proceeds to 211. At 209, the ECM 192 or the FCPS 199 (depending on the type of refueling) sends the refueling conflict to the FOTA supervisor 170 and the FOTA supervisor 170 does not cause the display of the FOTA NOW menu (e.g., FOTA Now or FOTA Scheduled selection screen for the customer), such as via the IPC 182. At 210, no FOTA update is performed and a normal vehicle powerdown occurs and the method 200 ends or returns to 201 during a next ignition-on cycle. At 211, the FOTA supervisor 170 does display the FOTA NOW menu to the customer. At 212, it is determined whether a customer selection of FOTA Now or FOTA Scheduled has been received from the customer within a timeout period. When false, the method 200 proceeds to 210. When true, the method 200 proceeds to 213 or 218 depending on whether the customer selection is FOTA Now or FOTA Scheduled, respectively.

At 213, the FOTA supervisor 170 sends the FOTA scheduled time to the ePT supervisory controller 154 and the ECM 192 or the FCPS 199 via the CAN. At 214, it is determined whether the propulsion system is impacted by the FOTA flash update. When false, the method 200 proceeds to 215 where the FOTA flash update is performed and a normal vehicle powerdown occurs and the method 200 ends or returns to 201 during a next ignition-on cycle. When true, the method 200 proceeds to 216 where it is determined whether any charging/discharging, engine/fuel cell system after-run, or cabin/12V conditioning conflicts are present. When false, the method 200 proceeds to 215. When true, the method 200 proceeds to 217 where these conflict(s) are handled as previously described herein and the FOTA update is performed based on the scheduled FOTA time and other factors. The method 200 then ends or returns to 201 during a next ignition-on cycle. At 218, it is determined whether the propulsion system is impacted by the FOTA flash update. When false, the method 200 proceeds to 215. When true, the method 200 proceeds to 219. At 219, it is determined whether any charging/discharging, engine/fuel cell system after-run, or cabin/12V conditioning conflicts are present. When false, the method 200 proceeds to 215. When true, the method 200 proceeds to 220 where the conflict(s) are handled as previously described herein and the FOTA update is performed. The method 200 then ends or returns to 201 during a next ignition-on cycle.

It will be appreciated that the terms “controller” and “control system as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A firmware over-the-air (FOTA) flash update control system for an electrified vehicle, the FOTA flash update control system comprising:
a FOTA supervisor module connected to a controller area network (CAN) of the electrified vehicle, the FOTA supervisor module configured to:
receive a FOTA flash update via a wireless communication medium and determine a set of controllers on the CAN that are intended to be flashed by the FOTA flash update, and
transmit, via the CAN, a FOTA applicability signal indicative of the set of controllers on the CAN that will be flashed by the FOTA flash update and a maximum FOTA time for performing the FOTA flash update; and
a propulsion supervisory controller connected to the CAN and configured to control a propulsion system of the electrified vehicle, based on the FOTA applicability signal, to overcome a conflict between the propulsion system and the performing of the FOTA flash update.

2. The FOTA flash update control system of claim 1, wherein the FOTA supervisor module is further configured to receive a customer input to either (i) perform the FOTA flash update immediately or (ii) to perform the FOTA flash update at a future scheduled time.

3. The FOTA flash update control system of claim 2, wherein the conflict includes an on-going or future scheduled charging session for a high voltage battery system of the electrified vehicle.

4. The FOTA flash update control system of claim 2, wherein the conflict includes an after-run procedure of an engine or a fuel cell system of the electrified vehicle.

5. The FOTA flash update control system of claim 2, wherein the propulsion supervisory controller is configured to not perform the FOTA flash update in response to determining that the electrified vehicle is experiencing a refueling operation.

6. The FOTA flash update control system of claim 2, wherein the FOTA flash update is performed after a completion of the conflict.

7. The FOTA flash update control system of claim 2, wherein the FOTA flash update is performed in priority ahead of the conflict in response to another customer input.

8. The FOTA flash update control system of claim 1, wherein when the set of controllers identified by the FOTA applicability signal do not include any controllers of the propulsion system, the propulsion supervisory controller is configured to continue operating the propulsion system of the electrified vehicle while the FOTA flash update is performed.

9. A firmware over-the-air (FOTA) flash update control method for an electrified vehicle, the FOTA flash update control method comprising:
receiving, by a FOTA supervisor module connected to a controller area network (CAN) of the electrified vehicle, a FOTA flash update via a wireless communication medium and determine a set of controllers on the CAN that are intended to be flashed by the FOTA flash update;
transmitting, by the FOTA supervisor module via the CAN, a FOTA applicability signal indicative of the set of controllers on the CAN that will be flashed by the FOTA flash update and a maximum FOTA time for performing the FOTA flash update; and
controlling, by a propulsion supervisory controller connected to the CAN, a propulsion system of the electrified vehicle, based on the FOTA applicability signal, to overcome a conflict between the propulsion system and the performing of the FOTA flash update.

10. The FOTA flash update control method of claim 9, further comprising receiving, by the FOTA supervisor module, a customer input to either (i) perform the FOTA flash update immediately or (ii) to perform the FOTA flash update at a future scheduled time.

11. The FOTA flash update control method of claim 10, wherein the conflict includes an on-going or future scheduled charging session for a high voltage battery system of the electrified vehicle.

12. The FOTA flash update control method of claim 10, wherein the conflict includes an after-run procedure of an engine or a fuel cell system of the electrified vehicle.

13. The FOTA flash update control method of claim 10, further comprising not performing, by the propulsion supervisory controller, the FOTA flash update in response to determining that the electrified vehicle is experiencing a refueling operation.

14. The FOTA flash update control method of claim 10, wherein the FOTA flash update is performed after a completion of the conflict.

15. The FOTA flash update control method of claim 10, wherein the FOTA flash update is performed in priority ahead of the conflict in response to another customer input.

16. The FOTA flash update control method of claim 9, wherein when the set of controllers identified by the FOTA applicability signal do not include any controllers of the propulsion system, the propulsion supervisory controller is configured to continue operating the propulsion system of the electrified vehicle while the FOTA flash update is performed.
